(19) United States
(12) Patent Application Publication
(10) Pub. No.: US 2015/0106159 A1
(43) Pub. Date: Apr. 16, 2015

(54) SYSTEM AND METHOD FOR DECENTRALIZING PUBLIC TRANSPORTATION PASSENGERS USING TRANSPORTATION CARD READER

(71) Applicant: Soonchunhyang University Industry Academy Cooperation Foundation, Asan-si (KR)

(72) Inventors: In Sik HONG, Asan-si (KR); Ji Won Kim, Suwon-si (KR); Su Bin Yang, Cheonan-si (KR); Seung Hyuk Lee, Suwon-si (KR)

(73) Assignee: Soonchunhyang University Industry Academy Cooperation Foundation, Asan-si (KR)

(21) Appl. No.: 14/080,726

(22) Filed: Nov. 14, 2013

(30) Foreign Application Priority Data
Oct. 15, 2013 (KR) 10-2013-0122552

(51) Int. Cl. G06Q 30/02; G06Q 50/26

(52) U.S. Cl. CPC G06Q 30/0201; G06Q 50/26
USPC 705/7.29

(57) ABSTRACT

Provided are a system and method for decentralizing public transportation passengers using a transportation card reader. The system includes a vehicle terminal including a transportation card reader counting the number of touches of transportation cards of riding and exiting passengers of a public transportation means and configured to transmit a count value to a center, an integrated database server provided in the center and configured to update a count value of each public transportation means with a transmitted count value of the public transportation means and transmit the updated count value to a station, a station terminal provided at the station and configured to display the updated and transmitted count value, and a mobile device configured to receive information on the riding and exiting passengers of the public transportation means from the integrated database server or the station terminal and output the received information.

### CROSS-REFERENCE TO RELATED APPLICATION

This application claims priority to and the benefit of Korean Patent Application No. 10-2013-0122552, filed on Oct. 15, 2013, the disclosure of which is incorporated herein by reference in its entirety.

### BACKGROUND

1. Field of the Invention

The present invention relates to a system and method for decentralizing public transportation passengers, and more particularly, to a public transportation passenger decentralization system and method that provide data of the number of public transportation passengers using a transportation card reader and thereby lead to decentralization of public transportation passengers.

2. Discussion of Related Art

Due to the development of public transportation, 60% or more citizens of the capital area in Korea use buses and subways as means of transportation these days. Since most citizens use public transportation as means of commuting, passengers are frequently concentrated at a specific time. By way of example, when an excessive number of passengers get on a bus, traveling speed is lowered, or the danger of an accident increases.

Although more buses and trains are put into service in the commuting time, such a trouble occurs. This is because, even when passengers know that a bus coming to a bus stop is overloaded, it is difficult to estimate a state of the next bus, and the passengers tend to get on the overloaded bus.

### SUMMARY OF THE INVENTION

The present invention is directed to a public transportation passenger decentralization system and method that count the number of passengers of public transportation through a transportation card reader in consideration of most public transportation passengers of the capital area using transportation cards, present the degree of congestion of passengers in a currently incoming public transportation means and the degree of congestion of passengers in the next public transportation means on an electronic display of a station and through a mobile public transportation information application in graphics, etc., and thereby lead to decentralization of public transportation passengers.

According to an aspect of the present invention, there is provided a system for decentralizing public transportation passengers using a transportation card reader, including: a vehicle terminal including a transportation card reader counting the number of touches of transportation cards of riding and exiting passengers of a public transportation means, and configured to transmit a count value to a center; an integrated database server provided in the center, and configured to update a count value of each public transportation means with a transmitted count value of the public transportation means and transmit the updated count value to a station; and a station terminal provided at the station, and configured to display the updated and transmitted count value.

The system may further include a mobile device configured to receive information on the riding and exiting passengers of the public transportation means from the integrated database server or the station terminal, and output the received information. Here, the integrated database server may transmit a response message using extensible markup language (XML) in response to a query message transmitted from the mobile device using hypertext transfer protocol (HTTP).

The vehicle terminal may use location information on the station, and transmit the location information and passenger number data to the integrated database server at a departing moment after a stop at the station.

The integrated database server may separately manage a static area for managing static data including the public transportation means and stations, and a dynamic area for managing dynamic data including locations of the public transportation means and the number of passengers in respective tables, and upon receiving passenger number data and a location of the public transportation means, the integrated database server may access information on a station at which the public transportation means will stop with reference to the static area while recording the passenger number data and the location of the public transportation means in the dynamic area, and multicast the number of passengers and the location information to a station terminal group using a Gateway Control Module (GCM) protocol.

The station terminal may display route numbers of the public transportation means, types of the public transportation means, an expected arrival time of and passenger number information on the closest public transportation means, and an expected arrival time of and passenger number information on the next public transportation means. At this time, the degree of congestion of the number of passengers may be designed in the form of a gauge, and a case in which the number of passengers is less than the number of seats of the public transportation means, a case in which the number of passengers is greater than or equal to 100% of the number of seats of the public transportation means and is less than or equal to 120% of the number of seats, and a case in which the number of passengers is greater than 120% of the number of seats of the public transportation means may be displayed in different gauge colors.

According to another aspect of the present invention, there is provided a method of decentralizing public transportation passengers using a transportation card reader, including: (a) transmitting, at a vehicle terminal, a count value of transportation cards of riding and exiting passengers touched to a transportation card reader to an integrated database server; (b) updating, at the integrated database server, a count value of each public transportation means with a transmitted count value of the public transportation means, and transmitting the updated count value to a station terminal; and (c) displaying, at the station terminal, the updated and transmitted count value.

(a) may include using, at the vehicle terminal, location information on a station, and transmitting the location information and passenger number data to the integrated database server at a departing moment after a stop at the station.

(b) may further include transmitting a response message to a mobile device using XML in response to a public transportation information request of the mobile device.

(b) may further include: separately managing, at the integrated database server, a static area for managing static data including the public transportation means and stations, and a dynamic area for managing dynamic data including locations of the public transportation means and the number of passengers in respective tables; and upon receiving passenger number data and a location of the public transportation means, accessing, at the integrated database server, information on a station at which the public transportation means will stop with reference to the static area while recording the passenger number data and the location of the public transportation means in the dynamic area, and multicasting the number of passengers and the location information to a station terminal group using a GCM protocol.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a structure diagram of a system for decentralizing public transportation passengers according to an exemplary embodiment of the present invention;

FIG. 2 is a conceptual diagram showing the operational flow of a vehicle terminal according to an exemplary embodiment of the present invention;

FIG. 3 is a block diagram of an integrated database server according to an exemplary embodiment of the present invention;

FIG. 4 shows a simulation module of a transportation card reader according to an exemplary embodiment of the present invention;

FIG. 5 shows a prototype layout of an electronic display at a bus station according to an exemplary embodiment of the present invention; and

FIG. 6 shows a prototype layout of a bus information application according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Description of the present invention will be followed by brief description of supporting technologies relating to the present invention (ODROID-X2, Linaro Ubuntu Linux, open Application Programming Interfaces (APIs), and extensible markup language (XML)).

In the present invention, description will be made by taking a bus as an example of a public transportation means. Needless to say, the present invention can be applied to all public transportation means including a subway, etc. as well as a bus.

In description of drawings, the same reference numeral will be given to components that perform the same function.

ODROID-X2

An ODROID-X2 board is an embedded board in which Exynos4412-prime Application Processor (AP) of Samsung Corp. is installed. The ODROID-X2 board is based on ARMv7 Industry Standard Architecture (ISA), and thus is suitable for installing an Android platform. The ODROID-X2 board shows high operating speed with 1.7 GHz ARM Cortex-A9 quad cores installed thereon. Also, the ODROID-X2 board supports many input/output (I/O) ports, such as universal serial bus (USB) 2.0, Universal Asynchronous Receiver Transmitter (UART), High Definition Multimedia Interface (HDMI), Ethernet, and General Purpose Input/Output (GPIO), and thus facilitates construction of an embedded server and manufacturing of an electronic display application for a bus stop [1].

Linaro Ubuntu Linux

Linaro is an organization that develops an open source of Linux, etc., for the ARM architecture. Representatively, Linaro has developed and released Ubuntu Linux, Android, Open Embedded, etc. for ARM, and all source code has been published under General Public License (GPL). Ubuntu Linux provides a high level of security due to support for multi-user and protection of a root account, which are typical characteristics of the Unix series, and thus is suitable for use in a server. Also, Ubuntu Linux is used by the largest number of users among free Linux distribution, and thus is easily maintained [2].

Open API

An open API is an API open to enable an Internet user not only to be unilaterally provided with search results, a user interface, etc. but also to develop application programs and service in person. Recently, as a necessity to use big data increases, a demand and necessity for opening public information to the public are in the limelight, and countries, local governments, public institutions, etc. are opening an increasing amount of information to the public through an open API. When developers request a permission to use the API from a public institution using the information, are issued an authentication key, and send a query to an institution server according to a protocol set by the institution, they can receive desired data as a response [3].

XML

XML is a multi-purpose markup language recommended by World Wide Web Consortium (W3C) to create other markup languages for special purposes. XML can be applied to describe numerous kinds of data, and has been mainly designed to enable different systems connected to the Internet to easily exchange data with each other. Most open APIs of major portal sites, domestic public institutions, etc. deliver data to users using XML. In general, to parse data received using XML, Java uses a Document Object Model (DOM) that is a static parser or a Simple API for XML (SAX) that is a dynamic parser [4].

Also in a system according to an exemplary embodiment of the present invention, XML is used for an integrated database server to transmit bus information.

Hereinafter, a system and method for decentralizing public transportation passengers using a transportation card reader according to exemplary embodiments of the present invention will be described in detail with reference to the accompanying drawings.

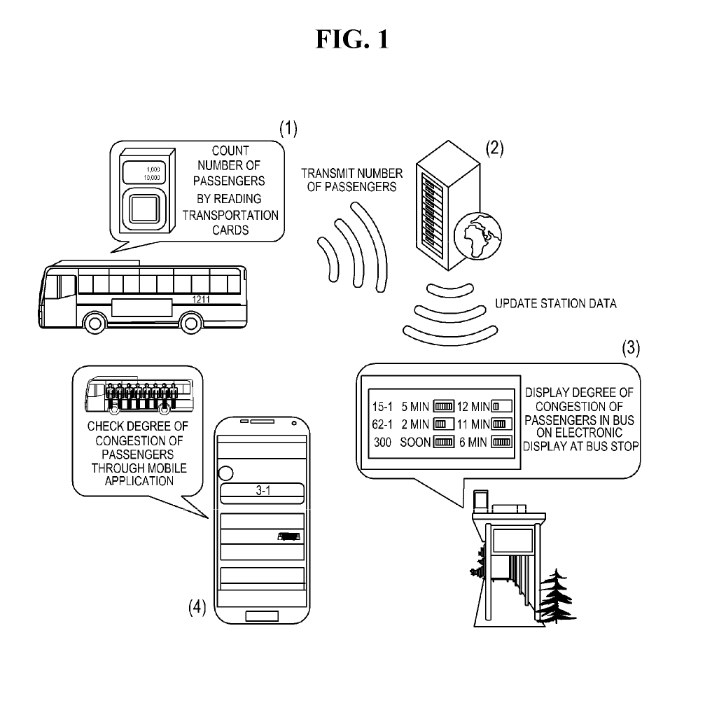

FIG. 1 is a structure diagram of a system for decentralizing public transportation passengers according to an exemplary embodiment of the present invention.

Referring to FIG. 1, a system for decentralizing public transportation passengers according to an exemplary embodiment of the present invention includes a vehicle terminal 1 counting touches of transportation cards of riding and exiting passengers of a public transportation means and transmitting a count value to a center, an integrated database server 2 provided in the center, updating a count value of each public transportation means with a transmitted count value of the public transportation means, and transmitting the updated count value to stations, and station terminals 3 provided at the stations and displaying the updated and transmitted count value.

Additionally, in an exemplary embodiment of the present invention, the system includes a mobile device 4 receiving information on riding and exiting passengers of public transportation means from the integrated database server 2 or the station terminals 3 and outputting the received information.

Here, the vehicle terminal 1 includes a transportation card reader capable of counting touches of transportation cards.

In the operation of the system constituted as above, the vehicle terminal 1 including the transportation card reader installed in a bus counts touches of transportation cards of riding and exiting passengers to measure the number of current passengers, and transmits the number to the integrated database server 2 together with a unique number of the bus. The integrated database server 2 receiving the passenger number data from the vehicle terminal 1 updates a database, and transmits the changed information to station terminals 3 located on a route of the bus.

Embedded processors installed in the station terminals 3 receive the new passenger number data and update data, and display information including a real-time passenger number of a first incoming bus and that of the next incoming bus on an electronic display of bus stops according to routes. Also, a user of the mobile device 4 may check the degree of congestion of passengers in a bus when checking bus information through a mobile device application. At this time, the mobile device 4 may be connected to the integrated database server 2 or a station terminal 3 through a wired/wireless network.

Passengers can make a reasonable selection by visually comparing the degree of congestion of passengers in an incoming bus with that of the next bus, and thereby passengers conventionally concentrated at a specific bus can be decentralized.

Vehicle Terminal (Transportation Card Reader)

An existing Bus Information System (BIS) is an integration of a vehicle terminal and a transportation card reader, and is only used for managing a bus service and using location information. In the system according to an exemplary embodiment of the present invention, the integrated vehicle terminal 1 counts the number of current passengers according to riding and exiting of passengers, and generates and stores a count value.

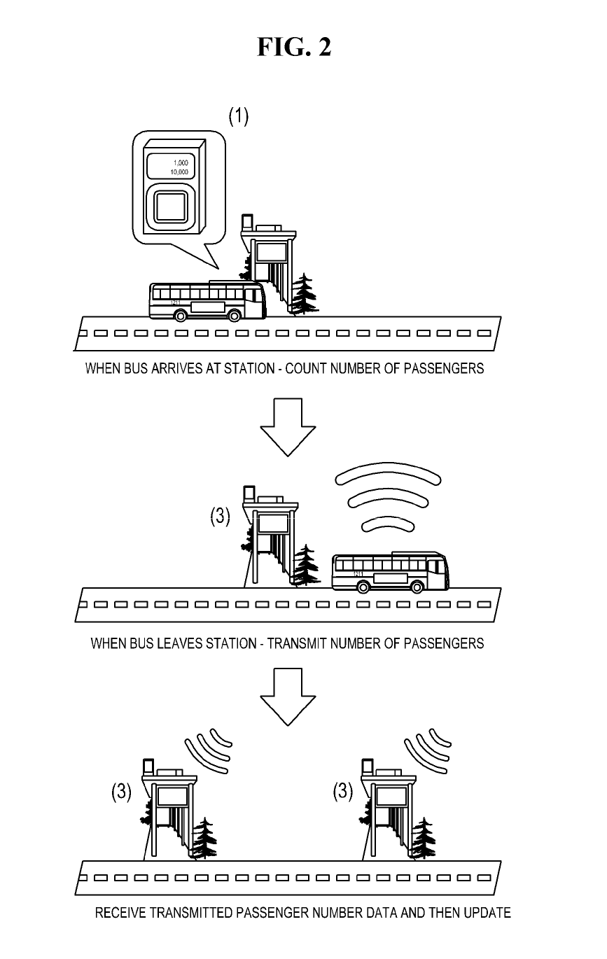

In principle, a bus enables passengers to get on and off at designated spots only, and thus the vehicle terminal 1 installed in a bus may reduce the load of the integrated database server 2 by transmitting passenger number data (count value) stored in the vehicle terminal 1 to the integrated database server 2 using location information only at a moment when the bus departs after a stop at a station. The determination that the bus leaves after a stop at a station can be made using an accelerometer of the bus, etc. while the vehicle terminal 1 is present in the wireless communication area of the station terminals 3. This is illustrated in FIG. 2 by way of operation of the vehicle terminal 1.

Integrated Database Server

The integrated database server 2 is an embedded server employing ORDROID-X2, and a server program is run on a Linaro Ubuntu system for smooth communication and security.

The database of the integrated database server 2 separately manages a static area for managing static data, such as unique information on buses and stations, and a dynamic area for managing dynamic data changing in real time, such as locations of the buses and the number of passengers, in respective tables.

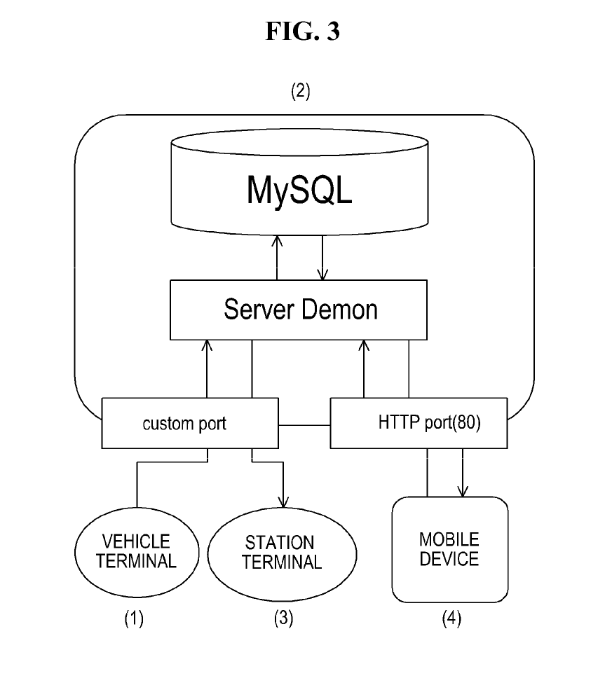

A constitution of the integrated database server 2 is illustrated in FIG. 3.

The server program performs one-way communication between the vehicle terminal 1 and the station terminals 3. When updated location information and passenger number information on a bus is received from the vehicle terminal 1, the server program accesses information on a station at which the bus will stop with reference to the static area while recording the location information and the passenger number information in the dynamic area of the database, and multicasts the passenger number and the location information to a group of target station terminals 3 using a Gateway Control Module (GCM) protocol.

Another operation of the integrated database server 2 is query and response with a mobile device application (referred to as “mobile device” below).

Communications for the query and response is performed through a port different than that of communication of the vehicle terminal 1, the integrated database server 2, and the station terminal 3. The integrated database server 2 exchanges information with the mobile device 4 using hypertext transfer protocol (HTTP) through port #80 that is a well-known port. When the mobile device 4 transmits a request message according to the determined protocol, the integrated database server 2 transmits back a response message using XML. As a method used by most existing open APIs, this maintains as high compatibility as possible with an existing bus information application, and can be easily applied to a BIS also.

Station Terminal

In the station terminals 3, ORDROID X2 is used, and the Android platform is installed, such that a GCM push message can be received. The station terminals 3 update location information and passenger number information on a bus received using a GCM, and display the location information and passenger number information on displays.

A display shows six kinds of information. A first kind of information is route numbers of buses, and a second kind of information is information on the types of the buses, such as a general city bus, a low-floor bus, an express city bus, and a wide-regional express bus. A third kind of information is an estimated arrival time of the closest bus among buses of the corresponding route number, and a fourth kind of information is information on the number of passengers in the bus. Successively, an estimated arrival time of and passenger number information on the next closest bus are displayed in parallel.

To effectively present the degree of congestion of passengers, a design in the form of a gauge is used in this system. When the number of passengers is less than the number of seats in a bus, it is determined that there are empty seats, and the gauge is displayed in green. When the number of passengers is greater than or equal to 100% of the number of seats in a bus and less than or equal to 120% of the number of seats, the gauge is displayed in orange, which means that there are as many standing passengers as the bus can smoothly run. When the number of passengers exceeds 120% of the number of seats in a bus, the gauge is displayed in red to indicate that the bus is crowded with passengers and may not smoothly run.

Mobile Device

Upon connection by the user, the mobile device 4 receives a station number or a desired bus route number from the user, queries the corresponding information to the integrated database server 2 using HTTP, and receives resultant response data using XML. The received data is parsed using a parser object, such that an estimated arrival time of and passenger number information on a bus may be extracted. Like a station display, on the bases of the extracted information, an application may present passenger number information on the closest bus and an arrival time of and passenger number information on the next bus. Since the mobile device 4 has less screen restrictions than a station display, it is possible to present information on more subsequent buses.

A method of decentralizing public transportation passengers using a transportation card reader according to an exemplary embodiment of the present invention in the system constituted as described above will be described.

In a method of decentralizing public transportation passengers using a transportation card reader according to an exemplary embodiment of the present invention, (a) a vehicle terminal transmits a count value of transportation cards of riding and exiting passengers touched to a transportation card reader to the integrated database server, (b) the integrated database server updates a count value of each public transportation means with the transmitted count value of the public transportation means and transmits the updated count values to a station terminal, and (c) the station terminal displays the updated and transmitted count value.

In step (a), the vehicle terminal uses location information on a station, and transmits the location information and passenger number data to the integrated database server at a departing moment after a stop at the station.

In step (b), the integrated database server transmits a response message to the mobile device using XML in response to a public transportation information request of the mobile device.

In step (b), the integrated database server separately manages a static area for managing static data including the public transportation means and stations, and a dynamic area for managing dynamic data including locations of the public transportation means and the number of passengers in respective tables, and upon receiving passenger number data and a location of the public transportation means, the integrated database server accesses information on a station at which the public transportation means will stop with reference to the static area while recording the passenger number data and the location of the public transportation means in the dynamic area, and multicasts the number of passengers and the location information to a station terminal group using the GCM protocol.

Implementation and Running of Decentralization System

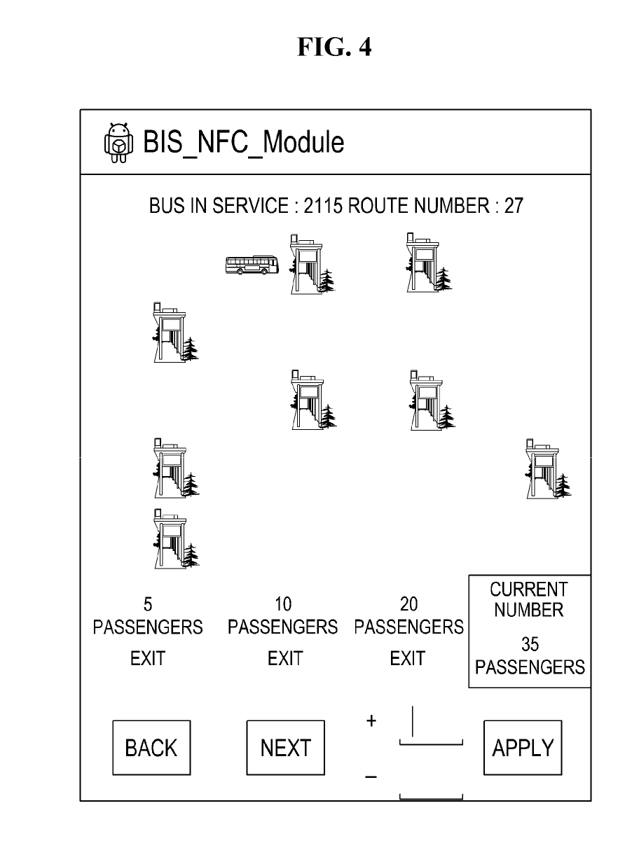

In the system for decentralizing public transportation passengers using a transportation card reader according to an exemplary embodiment of the present invention, the vehicle terminal 1 is implemented as a virtual simulation module in a smartphone device capable of reading a radio frequency identification (RFID) card instead of a transportation card reader of an actual bus. FIG. 4 shows a simulation module of a transportation card reader, which can virtually simulate the number of passengers by touching the simulation module with a designated transportation card while moving a bus in a determined station.

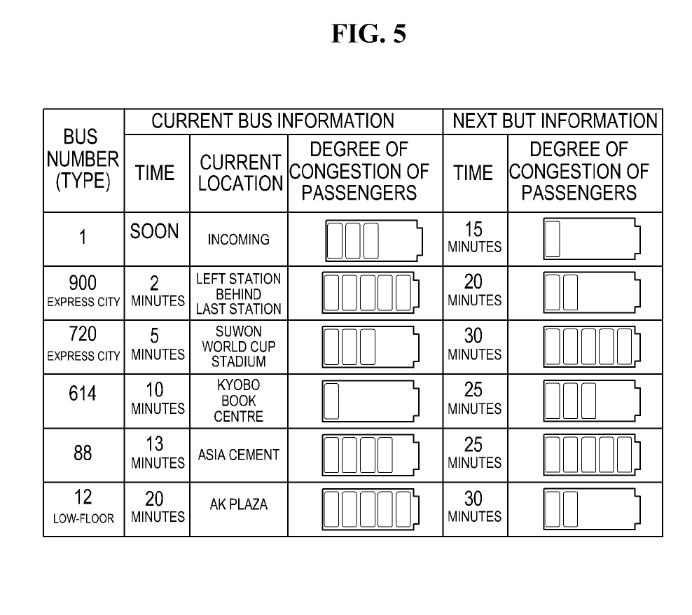

Bus location and passenger number data transmitted from the transportation card reader is reflected in the integrated database server 2, and displayed on an electronic display at a bus stop as shown in FIG. 5.

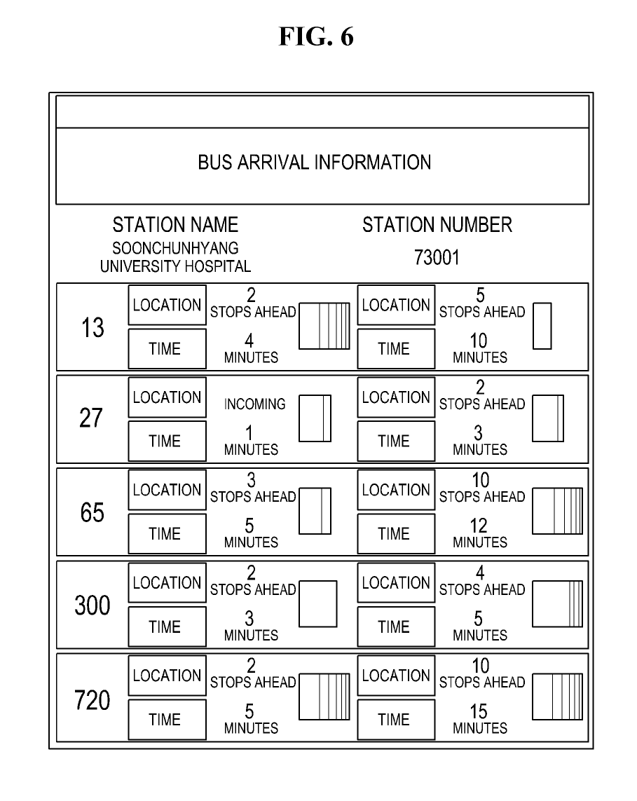

As shown in FIG. 6, the reflected bus location and passenger number information can also be checked through a bus information application by requesting XML data from the integrated database server 2.

As described above, an exemplary embodiment of the present invention proposes a system for decentralizing passengers using a transportation card reader to improve citizens' convenience of using public transportation and safety, such that the citizens can easily check the number of passengers in an incoming bus and that of the next bus through electronic displays at bus stops and mobile devices 4 and select and get on buses in which passengers are not concentrated. Accordingly, overload of a vehicle is prevented, and also it is possible to expect a reduction in fuel expenses.

The system according to an exemplary embodiment of the present invention has been designed to be compatible with BISs, which have already been used in cities and provinces, using the integrated vehicle terminal 1 in accordance with XML transfer through an open API. Accordingly, the system can be rapidly introduced and will bring forward realization of a ubiquitous (U)-city.

When a technique for sensing the number of passengers other than a transportation card reader is researched and developed hereafter, it is possible to develop a system for checking the number of persons waiting at a bus stop and a system for decentralizing waiting persons through measuring the number of passengers according to cars of a subway on the basis of the present invention.

As described above, in a system and method for decentralizing public transportation passengers according to exemplary embodiments of the present invention, when a currently incoming public transportation means is overloaded with passengers, it is possible to check the state of the next public transportation means and determine whether or not to get on the currently incoming public transportation means. Accordingly, it is possible to improve the convenience of public transportation passengers, increase the traveling speed of public transportation, and also reduce the danger of an accident.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for decentralizing public transportation passengers using a transportation card reader, comprising:
a vehicle terminal including a transportation card reader counting the number of touches of transportation cards of riding and exiting passengers of a public transportation means, and configured to transmit a count value to a center;
an integrated database server provided in the center, and configured to update a count value of each public transportation means with a transmitted count value of the public transportation means and transmit the updated count value to a station; and
a station terminal provided at the station, and configured to display the updated and transmitted count value.

2. The system of claim 1, further comprising a mobile device configured to receive information on the riding and exiting passengers of the public transportation means from the integrated database server or the station terminal, and output the received information.

3. The system of claim 2, wherein the integrated database server transmits a response message using extensible markup language (XML) in response to a query message transmitted from the mobile device using hypertext transfer protocol (HTTP).

4. The system of claim 1, wherein the vehicle terminal uses location information on the station, and transmits the location information and passenger number data to the integrated database server at a departing moment after a stop at the station.

5. The system of claim 1, wherein the integrated database server separately manages a static area for managing static data including the public transportation means and stations, and a dynamic area for managing dynamic data including locations of the public transportation means and a number of passengers in respective tables, and
upon receiving passenger number data and a location of the public transportation means, the integrated database server accesses information on a station at which the public transportation means will stop with reference to the static area while recording the passenger number data and the location of the public transportation means in the dynamic area, and multicasts the number of passengers and the location information to a station terminal group using a Gateway Control Module (GCM) protocol.

6. The system of claim 1, wherein the station terminal displays route numbers of the public transportation means, types of the public transportation means, an expected arrival time of and passenger number information on a closest public transportation means, and an expected arrival time of and passenger number information on a next public transportation means.

7. The system of claim 6, wherein a degree of congestion of passengers is designed in the form of a gauge, and
a case in which the number of passengers is less than a number of seats of the public transportation means, a case in which the number of passengers is greater than or equal to 100% of the number of seats of the public transportation means and is less than or equal to 120% of the number of seats, and a case in which the number of passengers is greater than 120% of the number of seats of the public transportation means are displayed in different gauge colors.

8. A method of decentralizing public transportation passengers using a transportation card reader, comprising:
(a) transmitting, at a vehicle terminal, a count value of transportation cards of riding and exiting passengers touched to a transportation card reader to an integrated database server;
(b) updating, at the integrated database server, a count value of each public transportation means with a transmitted count value of the public transportation means, and transmitting the updated count value to a station terminal; and
(c) displaying, at the station terminal, the updated and transmitted count value.

9. The method of claim 8, wherein (a) includes using, at the vehicle terminal, location information on a station, and transmitting the location information and passenger number data to the integrated database server at a departing moment after a stop at the station.

10. The method of claim 8, wherein (b) further includes transmitting a response message to a mobile device using extensible markup language (XML) in response to a public transportation information request of the mobile device.

11. The method of claim 8, wherein (b) further includes:
separately managing, at the integrated database server, a static area for managing static data including the public transportation means and stations, and a dynamic area for managing dynamic data including locations of the public transportation means and a number of passengers in respective tables; and
upon receiving passenger number data and a location of the public transportation means, accessing, at the integrated database server, information on a station at which the public transportation means will stop with reference to the static area while recording the passenger number data and the location of the public transportation means in the dynamic area, and multicasting the number of passengers and the location information to a station terminal group using a Gateway Control Module (GCM) protocol.
